(19) United States
(12) Patent Application Publication
(10) Pub. No.: US 2015/0056415 A1
(43) Pub. Date: Feb. 26, 2015

(54) METHOD FOR MANUFACTURING ULTRA LOW EXPANSION GLASS MIRROR SUBSTRATES

(71) Applicant: Goodrich Corporation, Charlotte, NC (US)

(72) Inventor: Bari Marc Southard, Danbury, CT (US)

(73) Assignee: GOODRICH CORPORATION, Charlotte, NC (US)

(21) Appl. No.: 14/162,829

(22) Filed: Jan. 24, 2014

Related U.S. Application Data
(60) Provisional application No. 61/868,277, filed on Aug. 21, 2013.

(51) Int. Cl. C03B 19/01; G02B 5/08; G02B 5/10

(52) U.S. Cl. CPC C03B 19/01; G02B 5/10; G02B 5/08; B33Y 10/00; B33Y 80/00
USPC 428/161; 65/17.3; 65/17.6; 428/172

(57) ABSTRACT

A method of manufacturing a mirror substrate that includes the steps of providing a polishable substrate surface layer formed from ultra low expansion (ULE) glass, depositing successive layers of powdered ULE glass onto the polishable substrate surface layer, and selectively lasing each successive layer of powdered ULE glass to produce successive fused layers of ULE glass joined to one another to form a mirror substrate having an optimized three-dimensional topology. A mirror substrate manufactured according to the prescribed method is also disclosed.

### CROSS-REFERENCE TO RELATED APPLICATION

This application claims the benefit of priority to U.S. Provisional Patent Application No. 61/868,277 filed Aug. 21, 2013 which is incorporated by reference herein in its entirety.

### BACKGROUND OF THE INVENTION

1. Field of the Invention

The subject invention relates to a method for manufacturing a mirror substrate, and more particularly, to a method for manufacturing an ultra low expansion (ULE) glass mirror substrate using an additive manufacturing process.

2. Description of Related Art

The mirror substrate of a reflective telescope mirror is commonly made of low expansion borosilicate glass, because it is a very stable material. Glass can also be polished to a very smooth and precise surface without any granular structure. After the glass surface of the mirror substrate has been precisely polished, it is turned into a front surface mirror by applying a very thin metallic coating thereto. The function of the glass substrate is to hold the shape of this thin metal layer which reflects light for the telescope.

Mirror substrates are often made with an internal honeycomb structure to have low weight and high stiffness. For example, it is known that a honeycomb structure can reduce the weight of a mirror substrate by a factor of five to seven times, as compared to a solid mirror substrate of equal dimensions. This helps to reduce cost and extend the functionality of a telescope.

Borosilicate glass is used for casting the honeycomb mirror substrates, because it has a relatively low coefficient of thermal expansion. The working point of the borosilicate glass is low enough that it can be molded into a complex honeycomb structures at temperatures which are easy to obtain.

Mirror substrates for large reflecting telescopes are polished to precise paraboloidal or nearly paraboloidal shapes. This shape can focus star light into an image just above the mirror. The rough paraboloidal shape is formed when a mirror blank is cast in a spinning furnace. By spinning the furnace at the proper speed while the glass is molten, the surface of the mirror takes on a paraboloidal shape. By the time the cooling process is complete, this surface is typically accurate to a fraction of an inch.

Mirrors made of ultra low expansion (ULE) glass are also known in the art. They exhibit virtually no dimensional changes over extreme temperature variations. Consequently, they are typically used for astronomical optics, including mirrors and lenses for telescopes in both space and terrestrial settings. One of the most well-known examples of the use of ULE is in the Hubble telescope's mirror.

ULE has a very low coefficient of thermal expansion and contains as components silica and less than 10% titanium dioxide. Its high resistance to thermal expansion makes ULE very resistant to high temperature thermal shock.

Additive manufacturing techniques are also known in the art, and have been used to manufacture a wide variety of mechanical components and parts, as well as finished end products. One form of additive manufacturing is called selective laser sintering (SLS), which involves the use of a high power laser (for example, a carbon dioxide laser) to fuse small particles of plastic, metal, ceramic or glass powders into a mass that has a desired three-dimensional shape.

In use, the laser selectively fuses the powdered material by scanning cross-sections generated from a 3-D digital description of the part (for example from a CAD file or scan data) on the surface of a powder bed. After each cross-section is scanned, the powder bed is lowered by one layer thickness, a new layer of material is applied on top, and the process is repeated until the part is completed.

Because finished part density depends on peak laser power, rather than laser duration, a SLS machine typically uses a pulsed laser. The SLS machine preheats the bulk powder material in the powder bed somewhat below its melting point, to make it easier for the laser to raise the temperature of the selected regions the rest of the way to the melting point.

Compared with other methods of additive manufacturing, SLS can produce parts from a relatively wide range of commercially available powder materials. These include polymers such as nylon (neat, glass-filled, or with other fillers) or polystyrene, metals including steel, titanium, alloy mixtures, and composites and green sand. The physical process can be full melting, partial melting, or liquid-phase sintering. Depending on the material, up to 100% density can be achieved with material properties comparable to those from conventional manufacturing methods.

It would be beneficial to provide a method for additively manufacturing a mirror substrate using an ultra low expansion glass that exhibits characteristics of light weight and high stiffness and is suitable for use in astronomical telescopes.

### SUMMARY OF THE INVENTION

The subject invention is directed to a new and useful method of manufacturing a mirror substrate, that includes the steps of providing a polishable substrate surface layer formed from ultra low expansion (ULE) glass, depositing successive layers of powdered ULE glass onto the polishable substrate surface layer, and selectively lasing each successive layer of powdered ULE glass to produce successive fused layers of ULE glass joined to one another to form a mirror substrate having an optimized three-dimensional topology.

Preferably, the polishable substrate surface layer has a prescribed geometry, such as for example a curved or paraboloidal surface geometry. It is envisioned that the step of selectively lasing each successive layer of powered ULE glass could involve either selective laser sintering, selective laser melting, or a similar laser-based additive manufacturing process.

The method of the subject invention also includes the step of optimizing the three-dimensional topology of the mirror substrate to obtain a specific stiffness for a given weight. For example, the optimized three-dimensional topology of the mirror substrate can be a ribbed structure or a honeycomb structure. It is also important to optimize the topology of the mirror substrate for minimal surface deformation in gravity, which is critical for metrology of space based telescope systems, as well as ground based systems in general. The subject invention is also directed to an optimized mirror substrate manufactured in accordance with the preceding method steps.

The subject invention is also directed to a method of manufacturing a mirror that includes the steps of providing a polishable substrate surface layer formed from ULE glass and having a prescribed surface geometry, depositing successive layers of powdered ULE glass onto the polishable substrate surface layer, selectively lasing each successive layer of powdered ULE glass to produce successive fused layers of ULE glass joined to one another to form a mirror substrate having an optimized three-dimensional topology, and providing the substrate surface layer with a reflective surface.

Preferably, the step of providing the substrate surface layer with a reflective surface includes the step of polishing the substrate surface layer, and the step of applying a reflective material to the polished substrate surface layer. More particularly, the step of applying a reflective material to the polished substrate surface layer includes applying a metalized coating to the polished substrate surface layer. The subject invention is also directed to a mirror having an optimized substrate that is manufactured according to the preceding method steps.

These and other features of the subject invention and the manner in which it is employed will become more readily apparent to those having ordinary skill in the art from the following enabling description of the preferred embodiments of the subject invention taken in conjunction with the several drawings described below.

### BRIEF DESCRIPTION OF THE DRAWINGS

So that those skilled in the art to which the subject invention appertains will readily understand how to make and use the subject invention without undue experimentation, preferred embodiments thereof will be described in detail herein below with reference to certain figures, wherein:

FIG. 1 is a schematic representation of a selective lasing operation in which an initial layer of powdered ULE glass is fused to a polishable mirror substrate surface layer; and

FIG. 2 depicts an example of an optimized mirror substrate having a ribbed structure.

### DETAILED DESCRIPTION OF PREFERRED EMBODIMENTS

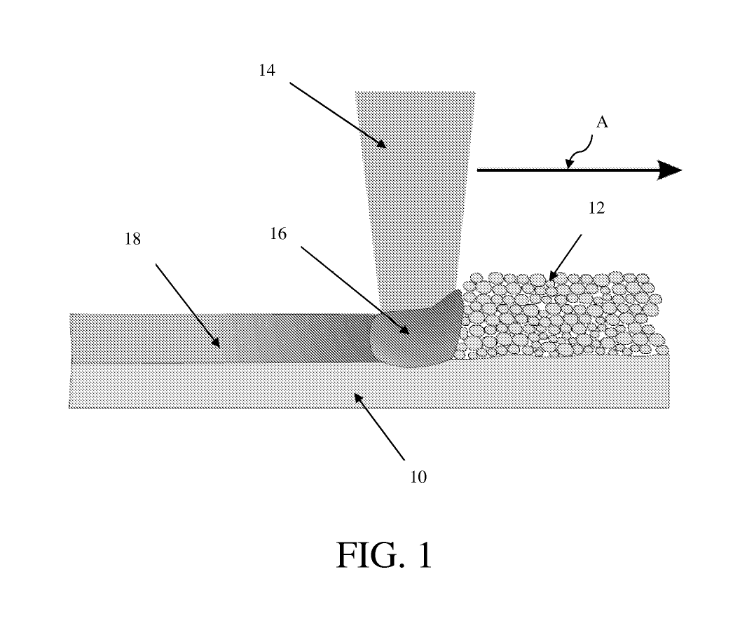

Referring now to the drawings wherein like reference numerals identify similar structural features or aspects of the subject invention, there is illustrated in FIG. 1 a schematic representation of a selective lasing operation for additively manufacturing an optimized mirror substrate in accordance with the method of the subject invention. The mirror substrate manufactured in accordance with the methodology of the subject invention is particularly useful in the construction, maintenance and/or repair of astronomical telescopes, including spaced-based and terrestrial-based telescopes

It is envisioned that the selective lasing process employed with the subject invention is either a selective laser sintering (SLS) process, a selective laser melting (SLM) process, or another suitable additive manufacturing technique known in the art. A method and apparatus for performing a selective lasing operation is disclosed, for example, in U.S. Pat. No. 4,863,538 to Deckard, which is herein incorporated by reference in its entirety.

Referring to FIG. 1, in performing the additive manufacturing method of the subject invention, a polishable mirror substrate surface layer 10 formed from ultra low expansion (ULE) glass is initially provided. It is envisioned that the substrate surface layer 10 would be provided on the surface of a powder bed of the SLS/SLM machine. The substrate layer 10 provides an initial platform to build structural features (e.g., ribbed structures) upon and has a prescribed surface geometry depending upon the application and operating environment. For example, in applications where the mirror substrate is intended for use as the primary mirror of a space-based astronomical telescope, the polishable substrate surface layer would have a curved, concave or nearly paraboloidal surface geometry. Alternatively, in applications where the mirror substrate is intended for use as the secondary mirror of a space-based astronomical telescope, the polishable substrate surface layer would have a curved or convex surface geometry or possibly a flat or planar surface geometry, depending upon the design of the telescope.

After providing the initial polishable mirror substrate surface layer 10 on the powder bed of the SLS/SLM machine, a layer of powdered ULE glass 12 is subsequently deposited onto the polishable substrate surface layer 10. The layer of powdered ULE glass 12 is then selectively lased using a high power laser 14 (e.g., a carbon dioxide laser), which creates a localized melt pool 16 supported by the neighboring glass powder 12. As the laser 14 scans in the direction of arrow A, it progressively transforms the small particles of ULE glass 12 into a fused mass or layer 18 that has a desired or predefined three-dimensional shape.

Thereafter, successive layers of powdered ULE glass are deposited one by one and the laser 14 selectively fuses the powdered material by scanning cross-sections generated from a three-dimensional description of the mirror substrate (for example a CAD file or scan data). As a result, successive fused layers of ULE glass are joined to one another, and the additive manufacturing process is repeated until the entire mirror substrate having an optimized three-dimensional topology is completed. Those skilled in the art will readily appreciate that the formation of curved surface layers within the mirror substrate can be managed by actively controlling the focus of the laser 14 or by actively controlling the vertical axis on laser.

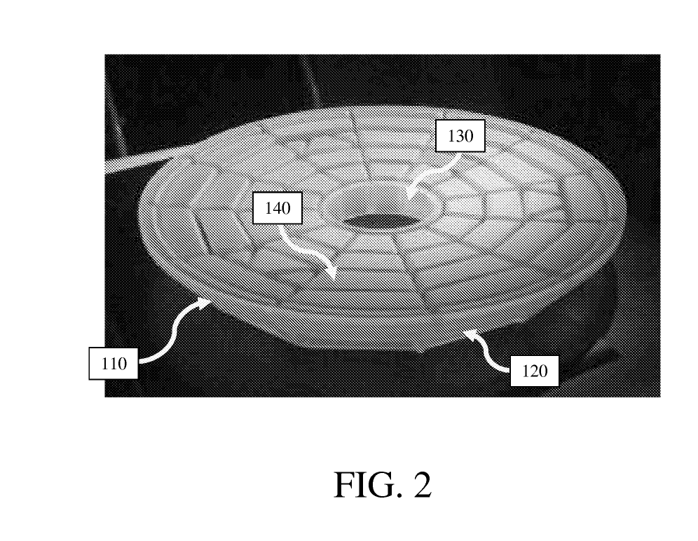

The optimization of the three-dimensional topology of the mirror substrate is done to obtain a specific stiffness for a given weight. For example, the optimized three-dimensional topology of the mirror substrate can be a ribbed structure as shown for example in FIG. 2, or a honeycomb structure as is known in the art. It is also important to optimize the topology of the mirror substrate for minimal surface deformation in gravity, which is critical for metrology of space based telescope systems, as well as ground based systems in general.

The optimized mirror substrate of the subject invention is constructed from ULE glass because ULE glass exhibits virtually no dimensional changes over extreme temperature variations. Indeed, ULE glass has a coefficient of thermal expansion of about 10⁻⁸/K at 5-35° C. Other characteristics includes a thermal conductivity of 1.31 w/(m·° C.), thermal diffusion of 0.0079 cm²/s, a mean specific heat of 767 J/(kg·° C.), a strain point of 890° C. [1634° F.], an estimated softening point of 1490° C. [2714° F.], and an annealing point of 1000° C. [1832° F.]. Also, ULE glass powder is recyclable, enabling very little material waste, which lowers material costs during production.

While other optical quality glasses are known, they tend to fracture or lose their mechanical properties when utilized in an SLS/SLM process as described. This is not the case however with ULE glass, which makes it so desirable for this purpose.

Referring now to FIG. 2, there is illustrated an example of an optimized mirror substrate 110 that can be manufactured by the additive manufacturing process of the subject invention, using either SLS or SLM techniques. By way of a non-limiting example, the mirror substrate 110 is constructed in the form of a primary telescope mirror and includes a polishable substrate surface layer 120 having a curved or nearly paraboloidal surface geometry. The mirror substrate 110 further includes an additively manufactured outer periphery 130 defined by a series of spaced apart hoops or belts. A central cylindrical hub 140 is additively formed at the center of the mirror substrate to define an aperture for allowing the passage of light therethrough to a secondary mirror of the telescope.

The subject invention is also directed to a method of manufacturing a mirror that includes the step of providing the polishable substrate surface 120 with a reflective surface finish. This treatment involves the initial step of polishing the substrate surface layer 120. This may be accomplished first by generated a precise prescribed shape with a numerically-controlled milling machine. The prescribed shape can be generated with a loose abrasive grind, or it may be generated using a spinning tool impregnated with diamond particles. Other grinding techniques known in the art can also be used. The grinding procedure improves the surface accuracy of the substrate surface 120 to about 50 microns (0.002 inch). The final shape of the substrate surface layer 120 is produced by polishing with a lap using a very fine polishing compound. This final shape is carefully polished to an accuracy of better than 25 nanometers (1.0×10⁻⁶ inch).

Those skilled in the art will appreciate that the substrate surface layer 120 should be polished to its precise prescribed shape within approximately 1/25 of the wavelength of light. For typical blue light, that means a surface accuracy of order 15-20 nanometers (less than 1.0×10⁻⁶ inch). Any small scale roughness (the lack of a good polish) will cause the light to be scattered and result in reduced contrast. Inaccuracies on larger scales, such as bending of the entire mirror, can result in an inability to focus the light into sharp images.

The method further includes the step of applying a reflective material to the polished substrate surface layer 120. More particularly, the step of applying a reflective material to the polished substrate surface layer includes applying a metalized coating to the polished substrate surface layer 120.

Aluminum is often used for this purpose, although silver or gold may be used depending upon the application and/or operating environment. The thickness of the metallized coating is typically ˜100 nm (4.0×10⁻⁶ inch) thick and weighs only a few grams. The metallized coating is applied in a vacuum chamber by evaporating a small amount of metal and allowing it to bond to the clean glass surface.

The additive manufacturing methods of the subject invention produce far thinner ribs and more optimized (complex) geometry than has been possible using conventional machining methods. The subject method also enables more efficient designs, and the formation of useful metrology/tooling features on the mirror substrate. For example, forming mount features or sections would not be an issue, and complex geometries to minimize stress are also possible using such additive manufacturing techniques.

There is also the potential to achieve greater production rates. For example, it is envisioned that the additive manufacturing process of the subject invention could produce a mirror substrate having a 4 m² core in three to four weeks' time, which is two orders of magnitude faster than could be achieved in mold casting production. This results in lower labor costs. There is also a lower manufacturing risk, since little or no mechanical stress is applied to the mirror substrate during the additive manufacturing process.

While the subject invention has been shown and described with reference to certain exemplary embodiments, such as the primary mirror substrate illustrated in FIG. 2 which has an optimized ribbed structure, those skilled in the art will readily appreciate that various changes and/or modifications may be made thereto without departing from the spirit and scope of the subject invention as defined by the appended claims.

What is claimed is:

1. A method of manufacturing a mirror substrate, comprising the steps of:
a) providing a polishable substrate surface layer formed from ULE glass;
b) depositing successive layers of powdered ULE glass onto the polishable substrate surface layer; and
c) selectively lasing each successive layer of powdered ULE glass to produce successive fused layers of ULE glass joined to one another to form a mirror substrate having an optimized three-dimensional topology.

2. A method according to claim 1, wherein the polishable substrate surface layer is provided with a prescribed geometry.

3. A method according to claim 1, wherein the step of selectively lasing comprises selective laser sintering.

4. A method according to claim 1, wherein the step of selectively lasing comprises selective laser melting.

5. A method according to claim 1, further comprising the step of optimizing the three-dimensional topology of the mirror substrate to obtain a specific stiffness for a given weight.

6. A method according to claim 5, wherein the optimized three-dimensional topology of the mirror substrate is a ribbed structure.

7. A method according to claim 1, further comprising the step of polishing the substrate surface layer.

8. A method according to claim 8, further comprising the step of applying a reflective material to the polished substrate surface layer.

9. A method according to claim 8, wherein the step of applying a reflective material to the polished substrate surface layer includes applying a metalized coating to the polished substrate surface layer.

10. An optimized mirror substrate manufactured according to the method of claim 1.

11. A method of manufacturing a mirror, comprising the steps of:
a) providing a polishable substrate surface layer formed from ULE glass and having a prescribed geometry;
b) depositing successive layers of powdered ULE glass onto the polishable substrate surface layer;
c) selectively lasing each successive layer of powdered ULE glass to produce successive fused layers of ULE glass joined to one another to form a mirror substrate having an optimized three-dimensional topology; and
d) providing the substrate surface layer with a reflective surface.

12. A method according to claim 11, wherein the prescribed geometry of the polishable substrate surface layer is a curved surface geometry.

13. A method according to claim 11, wherein the step of selectively lasing comprises selective laser sintering.

14. A method according to claim 11, wherein the step of selectively lasing comprises selective laser melting.

15. A method according to claim 11, further comprising the step of optimizing the three-dimensional topology of the mirror substrate to obtain a specific stiffness for a given weight.

16. A method according to claim 15, wherein the optimized three-dimensional topology of the mirror substrate is a ribbed structure.

17. A method according to claim 11, wherein the step of providing the substrate surface layer with a reflective surface includes the step of polishing the substrate surface layer.

18. A method according to claim 17, further comprising the step of applying a reflective material to the polished substrate surface layer.

19. A method according to claim 18, wherein the step of applying a reflective material to the polished substrate surface layer includes applying a metalized coating to the polished substrate surface layer.

20. A mirror having an optimized mirror substrate manufactured according to the method of claim 11.
